(19) United States
(12) Patent Application Publication
(10) Pub. No.: US 2016/0298407 A1
(43) Pub. Date: Oct. 13, 2016

(54) PLUG FOR WELL DRILLING PROVIDED WITH RING-SHAPED RATCHET STRUCTURE

(71) Applicant: KUREHA CORPORATION, Chuo-ku, Tokyo (JP)

(72) Inventors: TAKEO TAKAHASHI, Tokyo (JP); MASAYUKI OKURA, Tokyo (JP)

(21) Appl. No.: 15/029,410

(22) PCT Filed: Oct. 20, 2014
(86) PCT No.: PCT/JP2014/077832

§ 371 Date: Apr. 14, 2016

(30) Foreign Application Priority Data
Oct. 23, 2013 (JP) 2013-220224
Aug. 29, 2014 (JP) 2014-175337

(51) Int. Cl. E21B 29/02; E21B 33/128; C09K 8/42; E21B 43/26

(52) U.S. Cl. CPC E21B 29/02; E21B 43/26; E21B 33/128; C09K 8/426

(57) ABSTRACT

A plug for well drilling comprising a mandrel and members attached on an outer circumferential surface orthogonal to an axial direction of the mandrel, wherein at least one of the members or the mandrel is formed from a degradable material; a ring-shaped ratchet structure formed from a plurality of interlocking parts that allows movement of the member in one direction along the axial direction of the mandrel and restricts movement in the opposite direction is provided on an inner circumferential surface of the member and the outer circumferential surface of the mandrel; preferably further comprising a pushing jig including a ratchet structure and a ring-shaped plate adjacent to the axial direction leading side of the pushing jig. Additionally, a well drilling method using the plug for well drilling, comprising degrading a part or all of the plug after blocking a borehole.

### TECHNICAL FIELD

The present invention relates to a plug for well drilling used in well drilling for the purpose of producing hydrocarbon resources such as petroleum, natural gas, or the like; and a well drilling method.

### BACKGROUND ART

Hydrocarbon resources such as petroleum, natural gas, and the like have been excavated and produced through wells (oil wells and gas wells; hereinafter referred to collectively as “wells”) having porous and permeable subterranean formations. As energy consumption increases, deeper wells are being drilled, reaching depths greater than 9000 m worldwide and greater than 6000 m in Japan. In wells that are continuously excavated, methods in which fluid pressure is used to form fractures in the productive layer (also called “fracturing” or “hydraulic fracturing”), for the purpose of continuously excavating hydrocarbon resources efficiently from subterranean formations of which permeability has decreased over time and subterranean formations of which permeability is insufficient from the beginning, have received attention.

Hydraulic fracturing is a method in which fractures are generated in the productive layer by fluid pressure such as water pressure (also simply called “hydraulic pressure” hereinafter). Generally, a vertical hole is drilled, and then the vertical hole is curved and a horizontal hole is drilled in a subterranean formation several thousand meters underground. Fracturing fluid is then fed into these boreholes (meaning holes provided for forming a well, also called “downholes”) at high pressure, and fractures and the like are produced by the hydraulic pressure in the deep subterranean productive layer (layer that produces the hydrocarbon resource such as petroleum or natural gas), and the productive layer is thereby stimulated in order to extract and recover the hydrocarbon resource through the fractures and the like. The efficacy of hydraulic fracturing has also been examined for the development of unconventional resources such as shale oil (oil that matures in shale) and shale gas.

Fractures and the like formed by fluid pressure such as hydraulic pressure immediately close due to formation pressure when the hydraulic pressure is no longer applied. To prevent a fracture from closing, a proppant is included in the fracturing fluid (that is, the well treatment fluid used in fracturing), which is fed into the borehole, thereby distributing the proppant in the fracture. Inorganic or organic materials are used as proppants included in fracturing fluid, but silica and alumina and other inorganic particles have been conventionally used, and sand particles such as 20/40-mesh sand have been widely used because they are capable of preventing fracture closure in a very deep subterranean environment under high-temperature and high-pressure for a long time.

Various types of water-based, oil-based, and emulsion-based fluids are used as well treatment fluids such as fracturing fluid and the like. Because the well treatment fluid must have the function of transporting the proppant to the location where the fracture is generated in the borehole, it generally must have a prescribed viscosity, good proppant dispersibility, ease of after-treatment, and low environmental load. Furthermore, fracturing fluid sometimes contains a channelant in order to form flow paths through which shale oil, shale gas, and the like can pass among the proppant. Accordingly, in addition to the proppant, various additives are used in well treatment fluid, such as channelants, gelling agents, antiscale agents, acids for dissolving rock and the like, friction-reducing agents, and the like.

The following method is typically used to produce fractures by hydraulic pressure in the productive layer of a deep subterranean production layer (layer that produces the hydrocarbon resource, for example petroleum such as shale oil or natural gas such as shale gas or the like) using fracturing fluid. Specifically, a prescribed section of a borehole (downhole) drilled into a subterranean formation several thousand meters deep is partially plugged while blocking sequentially from the tip portion of the borehole, and fracturing fluid is fed at high pressure into the plugged section to produce fractures in the productive layer. Thereafter, the next prescribed section (typically before the leading section, specifically, the surface side section) is plugged and fracturing is carried out. This process is repeated until the necessary blocking and fracturing is completed.

Stimulation of the productive layer is sometimes also performed again not only for drilling of new wells but for desired sections of existing boreholes. In this case as well, the operations of borehole plugging, fracturing, and the like may be similarly repeated. Additionally, there are also cases where, to perform finishing of the well, the borehole is plugged to block fluid from below, and after the top portions finished, the plug is released.

Various methods are known for subsequent plugging and fracturing of boreholes from the tip portion of the borehole. For example, Patent Documents 1 to 3 disclose plugs for well drilling capable of plugging or fixing a borehole (also called a “frac plug,” “bridge plug,” “packer,” or the like).

For example, Patent Document 1 discloses a downhole plug for well drilling (also simply called “plug” hereinafter), and specifically discloses a plug comprising a mandrel (main body) having a hollow part in the axial direction, a ring or annular member along the axial direction on the outer circumferential surface orthogonal to the axial direction of the mandrel, a first conical member and slip, a malleable element formed from elastomer, rubber, or the like, a second conical member and slip, and an anti-rotation feature. Sealing of the borehole by a downhole plug for well drilling is performed as follows. Specifically, by moving the mandrel in the axial direction thereof, as the gap between the ring or annular member and the anti-rotation feature gets smaller, the slip contacts the slanted face of the conical member, and by proceeding along the conical member, it expands radially in the outward direction, contacts the inside wall of the borehole, and is fixed in the borehole to seal the borehole, and also, the malleable element deforms by diametric expansion, contacts the inside wall of the borehole, and seals the borehole. The mandrel has a hollow part in the axial direction, and the borehole can be sealed by setting a ball or the like therein. Patent Document 1 describes that metal materials (aluminum, steel, stainless steel, and the like), fibers, wood, composite materials, plastics, and the like are widely exemplified as materials that form plugs, and that composite materials containing a reinforcing material such as carbon fibers, especially polymeric substances such as epoxy resin, phenol resin, and the like, are preferred, and that the mandrel is formed from aluminum or a composite material. On the other hand, Patent Document 1 describes that, in addition to the previously described materials, a material that degrades depending on temperature, pressure, pH (acidic, basic), and the like may be used as the ball or the like.

Patent Document 2 discloses a packer assembly for well drilling where each packer is separably connected to each adjacent packer. Patent Document 2 recites a packer provided with a mandrel having a hollow part in the axial direction and, a slip, a slip wedge, a resilient packer element, an extrusion limiter, and the like along the axial direction on the outer circumferential surface orthogonal to the axial direction of the mandrel.

Downhole plugs for well drilling are arranged sequentially inside the well until the well is completed, but must be removed at the stage when production of petroleum such as shale oil or natural gas such as shale gas (hereinafter collectively called “petroleum and natural gas” or “petroleum or natural gas”) is begun. Because the plug is not designed to be released and retrievable after use, it is typically removed by destruction or by making it into small fragments by pulverization, drilling out, or another method, but substantial cost and time are required for pulverization, drilling out, and the like. There are also plugs specially designed to be retrievable after use (retrievable plugs), but since plugs are placed deep underground, substantial cost and time are required to retrieve all of them.

Patent Document 3 discloses a disposable downhole tool (meaning a downhole plug or the like) or a member thereof containing a degradable material that degrades when exposed to the environment inside a well, and as the biodegradable material, discloses a degradable polymer such as an aliphatic polyester such as polylactic acid. Additionally, Patent Document 3 describes a combination of a tubular body element having an axial-direction flow bore, a packer element assembly comprising an upper sealing element, a center sealing element, and a lower sealing element along the axial direction on the outer circumferential surface orthogonal to the axial direction of the tubular body member, a slip, and a mechanical slip body. Furthermore, Patent Document 3 discloses that fluid flow in only one direction is allowed due to the fact that a ball is set in the flow bore of the cylindrical body part. However, Patent Document 3 does not disclose whether a material containing a degradable material is used for a downhole tool or any part thereof.

With the increase in demand with regards to energy resource securement, environmental conservation and the like, and particularly as the mining of unconventional resources spreads, mining regulations such as those pertaining to mining at deeper levels have become stricter and more diversified. Plugs for well drilling (downhole tool) are transported to deep subterranean levels where fracturing is performed using a wire-like element (also called a “string”, “stinger”, “cable” or the like), move various members attached to the mandrel or the outer circumferential surface of the mandrel relatively so as to plug the borehole, and must withstand the pressure of high-pressure fluid and maintain plugging of the borehole during fracturing in which a high-pressure fluid is used. Specifically, plugs for well drilling such as downhole tools and downhole tool members must display sufficient resistance against high loads applied thereto when being transporting into the well, plugging a borehole and maintaining that plugging during fracturing. Accordingly, it has been desired that plugs for well drilling such as downhole tools and downhole tool members have a structure whereby plugging can be maintained and mechanical properties (strength, ductility, and other tensile-related properties and/or compression properties) whereby the plug can withstand pressures applied during operations associated with fracturing in the environment within the well.

Particularly, there are cases where a degradable material such as, for example, a decomposable resin material is used as the mandrel or the various members attached to the outer circumferential surface of the mandrel, that is, as a downhole tool as a plug for well drilling or a part or all of the members thereof, in order to make it possible to remove the plug or member via degradation after fracturing is completed. In such cases, the plug for well drilling must have sufficient strength to maintain the plugging in the environment within the well during the period until the completion of fracturing.

As mining regulations such as those pertaining to mining at deeper levels have become stricter and more diversified, there is a demand for a plug for well drilling and a well drilling method by which well drilling costs or steps can be reduced by withstanding the large load placed on the plug so as to reliably be transported into the well, plug the borehole, and carry out fracturing; and facilitating the removal of the plug and the securing of the flow path.

### CITATION LIST

### Patent Literature

Patent Document 1: US Patent Application Publication No. 2011/0277989 A1 specification

Patent Document 2: US Patent Application Publication No. 2003/0183391 A1 specification

Patent Document 3: US Patent Application Publication No. 2005/0205266 A1 specification

### SUMMARY OF INVENTION

### Technical Problem

As mining regulations such as those pertaining to mining at deeper levels have become stricter and more diversified, an object of the present invention is to provide a plug for well drilling and a well drilling method by which well drilling costs or steps can be reduced by withstanding the large load placed on the plug so as to reliably be transported into the well, plug the borehole, and carry out fracturing; and facilitating the removal of the plug and the securing of the flow path. A further object of the present invention is to provide a well drilling method in which said plug for well drilling is used.

### Solution to Problem

As a result of diligent research to solve the problems described above, the present inventors discovered that, in a plug for well drilling comprising a mandrel and members attached on an outer circumferential surface orthogonal to the axial direction of the mandrel, the technical problems of the invention could be solved by forming at least a portion of the members from a degradable material and specifying a coupling mechanism of the mandrel and the members. Thus the present invention was completed.

Specifically, a first aspect of the present invention provides: (1) a plug for well drilling comprising a mandrel and members attached on an outer circumferential surface orthogonal to an axial direction of the mandrel, wherein:

a) at least one of the members or the mandrel is formed from a degradable material, and

b) a ring-shaped ratchet structure orthogonal to the axial direction of the mandrel is provided on an inner circumferential surface of at least one of the members and the outer circumferential surface of the mandrel, the ring-shaped ratchet structure being formed from a plurality of interlocking parts that allow movement of the members in one direction along the axial direction of the mandrel and restrict movement in the opposite direction.

Another aspect of the present invention provides the plug for well drilling described in (2), below.

(2) A plug for well drilling comprising a mandrel and members attached on an outer circumferential surface orthogonal to an axial direction of the mandrel, wherein:

a1) the mandrel is formed from a degradable material;

a2) at least one of the members is formed from a degradable material; and

b) a ring-shaped ratchet structure orthogonal to the axial direction of the mandrel is provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction.

Yet other aspects of the present invention provide the plug for well drilling described in (3) to (8), below.

(3) The plug for well drilling described in (1) or (2), wherein the member attached on the outer circumferential surface orthogonal to the axial direction of the mandrel, having the plurality of interlocking parts formed on the inner circumferential surfaces thereof is at least one selected from the group consisting of a slip, a wedge, a pair of ring-shaped fixing members, and a diametrically expandable circular rubber member.

(4) The plug for well drilling described in any one of (1) to (3), wherein the member attached on the outer circumferential surface orthogonal to the axial direction of the mandrel, having the plurality of interlocking parts formed on the inner circumferential surfaces thereof is one or a plurality of pushing jigs.

(5) The plug for well drilling described in (4), wherein at least one of the pushing jigs is one of the pair of ring-shaped fixing members.

(6) The plug for well drilling described in (4) or (5), wherein at least one of the pushing jigs comprises a support ring formed from at least one of a metal and a degradable material, and an inner circumferential surface of the support ring contacts the outer circumferential surface of a ratchet structured ring having interlocking parts that form a ring-shaped ratchet structure on an inner circumferential surface thereof.

(7) The plug for well drilling described in any one of (4) to (6), further comprising a ring-shaped plate adjacent to a leading side along the axial direction of the mandrel of at least one of the pushing jigs.

(8) The plug for well drilling described in (7), wherein the ring-shaped plate is formed from at least one of a degradable material and a metal.

Yet other aspects of the present invention provide the plug for well drilling described in (9) to (21), below.

(9) The plug for well drilling described in any one of (1) to (8), wherein at least one of the following i) to iii) applies to the mandrel formed from the degradable material:

i) is formed from a degradable material having a shearing stress of 30 MPa or greater at a temperature of 66° C.;

ii) has a thickness reduction of less than 5 mm after being immersed in water of a temperature of 66° C. for one hour, and has a thickness reduction of 10 mm or greater after being immersed in water of a temperature of 149° C. for 24 hours; and

iii) a tensile load capacity of the interlocking parts of the ratchet structure is 5 kN or greater at a temperature of 66° C.

(10) The plug for well drilling described in any one of (1) to (9) wherein, at least one of the members attached on the outer circumferential surface orthogonal to the axial direction of the mandrel is formed from a degradable material having a shearing stress of 30 MPa or greater at a temperature of 66° C.

(11) The plug for well drilling described in any one of (1) to (10), wherein a gross tensile load capacity is 100 kN or greater.

(12) The plug for well drilling described in any one of (1) to (11), wherein a gross tensile load capacity of the ring-shaped ratchet structure is 50 kN or greater.

(13) The plug for well drilling described in any one of (1) to (12), wherein the ring-shaped ratchet structure is formed so as to cover one or both of the outer circumferential surface of the mandrel and the inner circumferential surface of the members attached on the outer circumferential surface orthogonal to the axial direction of the mandrel.

(14) The plug for well drilling described in any one of (3) to (13), wherein the pair of ring-shaped fixing members is capable of fixing the diametrically expandable circular rubber member attached on the outer circumferential surface orthogonal to the axial direction of the mandrel in a compressed state.

(15) The plug for well drilling described in any one of (3) to (14) wherein, at least one of a combination of the slip and the wedge is disposed between the pair of ring-shaped fixing members.

(16) The plug for well drilling described in (15), comprising a plurality of the combination of the slip and the wedge.

(17) The plug for well drilling described in any one of (1) to (16), wherein the mandrel comprises a hollow part along the axial direction.

(18) The plug for well drilling described in any one of (1) to (17), wherein the degradable material is an aliphatic polyester.

(19) The plug for well drilling described in (18), wherein the aliphatic polyester is polyglycolic acid.

(20) The plug for well drilling described in (19), wherein the polyglycolic acid has a weight average molecular weight from 180000 to 300000, and a melt viscosity recorded at a temperature of 270° C. and a shear rate of 122 sec⁻¹ from 700 to 2000 Pa·s.

(21) The plug for well drilling described in any one of (1) to (20), wherein the degradable material comprises a reinforcing material.

Furthermore, yet another aspect of the present invention provides: (22) a well drilling method using the plug for well drilling described in any one of (1) to (21), the method comprising degrading a part or all of the plug for well drilling after blocking a borehole.

As an embodiment thereof, the following is provided: (23) The well drilling method described in (22) comprising degrading the ring-shaped ratchet structure.

### ADVANTAGEOUS EFFECTS OF INVENTION

A first aspect of the present invention provides a plug for well drilling comprising a mandrel and members attached on an outer circumferential surface orthogonal to an axial direction of the mandrel, wherein:

a) at least one of the members or the mandrel is formed from a degradable material, and

b) a ring-shaped ratchet structure orthogonal to the axial direction of the mandrel is provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction.

In light of mining regulations such as those pertaining to mining at deeper levels becoming stricter and more diversified, and as a result of the configuration described above, a plug for well drilling is provided by which advantageous effects are provided in that well drilling costs and steps can be reduced by withstanding the large load placed on the plug so as to reliably be transported into the well, plug the borehole, and carry out fracturing; and facilitating the removal of the plug and the securing of the flow path.

Additionally, another aspect and yet still another aspect of the present invention provide a plug for well drilling comprising a mandrel and members attached on an outer circumferential surface orthogonal to an axial direction of the mandrel, wherein:

a1) the mandrel is formed from a degradable material;

a2) at least one of the members is formed from a degradable material;

b) a ring-shaped ratchet structure orthogonal to the axial direction of the mandrel is provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction; and furthermore

c) the plug for well drilling comprises one or multiple pushing jigs enveloping the ring-shaped ratchet structure; and

d) the plug for well drilling comprises a ring-shaped plate adjacent to a leading side along the axial direction of the mandrel of at least one of the pushing jigs.

In light of mining regulations such as those pertaining to mining at deeper levels becoming stricter and more diversified, and as a result of the configuration described above, a plug for well drilling is provided by which advantageous effects are provided in that well drilling costs and steps can be reduced by withstanding the large load placed on the plug so as to reliably be transported into the well, plug the borehole, and carry out fracturing; and facilitating the removal of the plug and the securing of the flow path.

Additionally, another aspect of the present invention provides a well drilling method using the plug for well drilling, the method comprising degrading a part or all of the plug for well drilling after blocking a borehole.

As mining regulations such as those pertaining to mining at deeper levels have become stricter and more diversified, and as a result of the method described above, a well drilling method is provided by which advantageous effects are provided in that well drilling costs and steps can be reduced by withstanding the large load placed on the plug so as to reliably be transported into the well, plug the borehole, and carry out fracturing; and facilitating the removal of the plug and the securing of the flow path.

### BRIEF DESCRIPTION OF DRAWINGS

FIG. 1A is a schematic cross-sectional view illustrating a specific example of a plug for well drilling of the present invention.

FIG. 1B is a schematic cross-sectional view illustrating a state where a diametrically expandable circular rubber member of the plug for well drilling is diametrically expanded.

FIG. 2 is a schematic cross-sectional view illustrating a specific example of a ring-shaped ratchet structure orthogonal to the axial direction of the mandrel in the plug for well drilling of the present invention.

FIG. 3 is a schematic partial cross-sectional view illustrating a specific example of the plug for well drilling of the present invention provided with the pushing jig.

FIG. 4A is a schematic partially enlarged cross-sectional view illustrating the vicinity of the ratchet structure in a specific example of the plug for well drilling of the present invention provided with the pushing jig and the ring-shaped plate.

FIG. 4B is a schematic partially enlarged cross-sectional view illustrating the vicinity of the ratchet structure when the ratchet structured ring of the pushing jig depicted in FIG. 4A is in contact with the ring-shaped plate.

### DESCRIPTION OF EMBODIMENTS

The present invention relates to a plug for well drilling comprising a mandrel and members attached on an outer circumferential surface orthogonal to an axial direction of the mandrel, wherein:

a) at least one of the members or the mandrel is formed from a degradable material, and

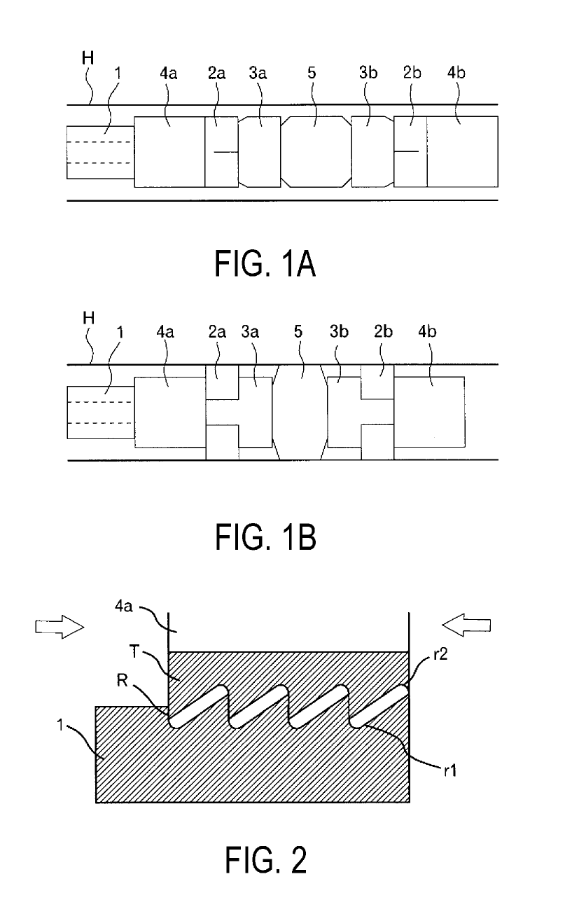

b) a ring-shaped ratchet structure orthogonal to the axial direction of the mandrel is provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction. The present invention is described below while referencing FIGS. 1A and 1B.

### I. Plug for Well Drilling

### 1. Mandrel

The plug for well drilling of the present invention is provided with a mandrel and members attached on the outer circumferential surface orthogonal to the axial direction of the mandrel. The mandrel 1 provided in the plug for well drilling of the present invention is normally called a “core metal,” of which the cross-section has a substantially circular shape. The length of the mandrel 1 is sufficiently long relative to the diameter of the cross-section, and the mandrel 1 basically assures the strength of the plug for well drilling of the present invention. In the mandrel 1 provided in the plug for well drilling of the present invention, the diameter of the cross-section is selected as appropriate according to the size of the borehole (by making it slightly smaller than the inner diameter of the borehole, the plug can move inside the borehole, while on the other hand, as will be described later, there is a difference in diameter to an extent that enables borehole plugging via the diametric expansion of a diametrically expandable circular rubber member 5 or the like). The length of the mandrel 1 is, for example, approximately 5 to 20 times the diameter of the cross-section but is not limited thereto. Typically, the diameter of the cross-section of the mandrel 1 is in a range of 5 to 30 cm.

### [Hollow Part]

The mandrel 1 provided in the plug for well drilling of the present invention may be solid, but from the perspectives of securing a flow path at early stages of fracturing, reducing the weight of the mandrel, and controlling the degradation rate of the mandrel, the mandrel 1 is preferably a hollow mandrel comprising in at least a portion thereof a hollow part along the axial direction (the hollow part may be configured to penetrate the mandrel along the axial direction, or it may be configured not penetrate the mandrel along the axial direction). Additionally, in cases where the mandrel 1 is force-transported the plug for well drilling into a borehole using a fluid, the mandrel 1 preferably comprises the hollow part along the axial direction. When the mandrel 1 has a hollow part along the axial direction, the cross-sectional shape of the mandrel 1 is a circular shape formed by two concentric circles forming the diameter (outside diameter) of the mandrel 1 and the outside diameter of the hollow part (corresponding to the inside diameter of the mandrel 1). The ratio of the diameters of the two concentric circles—that is, the ratio of the outside diameter of the hollow part to the diameter of the mandrel (core rod) 1—is preferably at most 0.7. The magnitude of this ratio has a reciprocal relationship with the magnitude of the ratio of the thickness of the hollow mandrel 1 to the diameter of the mandrel 1, so determining the upper limit of this ratio can be considered equivalent to determining a preferable lower limit of the thickness of the hollow mandrel. When the thickness of the hollow mandrel is too thin, the strength (in particular, the tensile strength) of the hollow mandrel may be insufficient when the plug for well drilling is placed inside a borehole or at the time of borehole plugging or fracturing, which may, in extreme cases, result in damage to the plug for well drilling. Therefore, the ratio of the outside diameter of the hollow part to the diameter of the mandrel 1 is more preferably at most 0.6 and even more preferably at most 0.5.

The diameter of the mandrel 1 and/or the outer diameter of the hollow part may be uniform along the axial direction of the mandrel 1, but may also vary along the axial direction. That is, bent portions such as convex parts, stepped parts, flanges, concave parts (grooves), and also screw parts, or the like may be formed on the outer circumferential surface of the mandrel 1 due to the fact that the outside diameter of the mandrel 1 varies along the axial direction. In addition, bent portions such as convex parts, stepped parts, flanges, concave parts (grooves), and also screw parts, or the like may be formed on the inner peripheral surface of the mandrel 1 when the outside diameter of the hollow part varies along the axial direction. Furthermore, the bent portions may comprise a tapered part.

The convex parts, stepped parts, flanges, and concave parts (grooves) provided on the outer circumferential surface and/or the inner circumferential surface of the mandrel 1 can be used as bearing sites when transporting the plug for well drilling into a borehole, and can also be used as sites for attaching and/or fixing other members to the outer circumferential surface and/or the inner circumferential surface of the mandrel 1. In cases where the mandrel 1 has a hollow part, the hollow part can be used as a seat for holding a ball used to control the flow of a fluid.

### [Material Forming the Mandrel]

The material forming the mandrel 1 provided in the plug for well drilling of the present invention is not particularly limited. Materials used conventionally in the forming of mandrels provided in plugs for well drilling can be used. Examples include, metal materials (aluminum, steel, stainless steel, and the like), fibers, wood, composite materials, and resins. Specific examples include composite materials including carbon fibers or similar reinforcing materials, and particularly composite materials including an epoxy resin, phenol resin, or similar polymeric substances. As the plug for well drilling of the present invention will be able to reduce the costs and steps of well drilling as a result of the plug being removed following the completion of fracturing and the securing of the flow path being facilitated, the mandrel 1 is preferably formed from a degradable material.

### [Degradable Material]

In the plug for well drilling of the present invention, in cases where the mandrel 1 is formed from the degradable material, as described hereinafter, biodegradable materials, degradable materials having hydrolyzability, and other degradable materials that can be chemically degraded through some other process can be used as the degradable material.

Materials such as aluminum and similar metal materials are commonly used to form the mandrel provided in conventional plugs for well drilling. Such materials are prone to mechanical degradation such as destruction, disintegration, or the like and are not suitable as the degradable material forming the mandrel 1 provided in the plug for well drilling of the present invention. However, materials in which the intrinsic strength of resin decreases and the resin becomes weak due to a reduction in the degree of polymerization or the like, resulting in it disintegrating and losing its shape upon application of a very small mechanical force, also qualify as degradable materials. Examples of such degradable materials include composite materials including a decomposable resin and a metal material (described hereinafter).

In the plug for well drilling of the present invention, in cases where the mandrel 1 is formed from the degradable material, as described hereinafter, the degradable material is preferably a hydrolyzable material that degrades in water of a certain or higher temperature. Additionally, the degradable material is more preferably an aliphatic polyester, and even more preferably polyglycolic acid. Furthermore, the degradable material may comprise a reinforcing material, and may also comprise other compounding components. Additionally, in cases where the mandrel 1 is formed from the degradable material and also includes bent portions such as convex parts, stepped parts, flanges, and concave parts (grooves), and also screw parts, or the like, a curvature radius of the bent portions is preferably from 0.5 to 50 mm.

The degradable material used in the plug for well drilling of the present invention is described in further detail below. The degradable material may be a degradable material that is, for example, biodegradable, meaning that it is degraded by microorganisms in the soil in which the fracturing fluid and the like are used, or hydrolyzable, meaning that it is degraded by a solvent in the fracturing fluid, particularly by water, and also by acids or alkalis if desired. Additionally, it may be a degradable material that can be degraded chemically by some other method. Preferably, the degradable material is a hydrolyzable degradable material degraded by water of a certain or higher temperature.

### [Decomposable Resin]

A decomposable resin is preferred as the degradable material because it must have the strength expected for a material used in a high-temperature, high-pressure deep subterranean environment while also having excellent degradability. A decomposable resin means a resin that is biodegradable, hydrolyzable, or can be degraded chemically some other method, as described above. Examples of the decomposable resin include aliphatic polyesters such as polylactic acid, polyglycolic acid, and poly-ε-caprolactone, and polyvinyl alcohols (partially saponified polyvinyl alcohols and the like having a degree of saponification of 80 to 95 mol %) and the like, but it is more preferably an aliphatic polyester. That is, the degradable material is preferably an aliphatic polyester. The decomposable resin may be one type alone or a combination obtained by blending two or more types. Additionally, in cases where the member attached on the outer circumferential surface orthogonal to the mandrel 1 formed from the degradable material is a diametrically expandable circular rubber member, examples of degradable materials that can be used include aliphatic polyester-based rubbers, polyurethane rubbers, natural rubbers, polyisoprene, and similar biodegradable rubbers.

### [Aliphatic Polyester]

The aliphatic polyester is, for example, obtained from homopolymerization or copolymerization of an oxycarbonic acid and/or a lactone, an esterification reaction of aliphatic dicarboxylic acid and an aliphatic diol, or copolymerization of aliphatic dicarboxylic acid, an aliphatic diol, and an oxycarbonic acid and/or a lactone; and preferably dissolves rapidly in water having a temperature from about 20 to 100° C.

Examples of the oxycarbonic acid include, glycolic acid, lactic acid, malic acid, hydroxypropionic acid, hydroxybutyric acid, hydroxypentanoic acid, hydroxycaproic acid, hydroxyheptanoic acid, hydroxyoctanoic acid, and similar aliphatic hydroxycarboxylic acids having from 2 to 8 carbons, and the like. Examples of the lactone include propiolactone, butyrolactone, valerolactone, ε-caprolactone, and similar lactones having from 3 to 10 carbons, and the like.

Examples of the aliphatic dicarboxylic acid include, oxalic acid, malonic acid, succinic acid, glutaric acid, adipic acid, and similar aiphatic saturated dicarboxylic acids having from 2 to 8 carbons; maleic acid, fumaric acid, and similar aiphatic unsaturated dicarboxylic acids having from 4 to 8 carbons; and the like. Examples of the aliphatic diol include, ethylene glycol, propylene glycol, butane diol, hexane diol, and similar alkylene glycols having from 2 to 6 carbons; polyethylene glycol, polypropylene glycol, polybutylene glycol, and similar polyalkylene glycols having from 2 to 4 carbons; and the like.

One type alone or a combination obtained by blending two or more types of components may be used to form these polyesters. Furthermore, components that form an aromatic polyester such as terephthalic acid may be used in combination provided that the properties as a decomposable resin are not lost.

Examples of particularly preferable aliphatic polyesters as the degradeable resin include, polylactic acid (hereinafter referred to also as “PLA”), polyglycolic acid (hereinafter referred to also as “PGA”), and similar hydroxycarboxylic acid-based aliphatic polyesters; poly-ε-caprolactone and similar lactone-based aliphatic polyesters; polyethylene succinate, polybutylene succinate, and similar diol-dicarboxylic acid-based aliphatic polyesters; copolymers of these, including, for example, poly(lactic-co-glycolic acid) (hereinafter referred to also as “PGLA”); as well as mixtures of these; and the like. Another example is an aliphatic polyester used by combining polyethylene adipate/terephthalate or similar aromatic components.

From the perspective of the strength and degradability required in the mandrel 1 of the plug for well drilling, the aliphatic polyester is most preferably at least one type selected from the group consisting of PGA, PLA, and PGLA, of which PGA is even more preferred. The PGA encompasses not only homopolymers of glycolic acid, but also copolymers containing not less than 50 mass %, preferably not less than 75 mass %, more preferably not less than 85 mass %, even more preferably not less than 90 mass %, particularly preferably not less than 95 mass %, most preferably not less than 99 mass %, and above all, preferably not less than 99.5 mass %, of glycolic acid repeating units. The PLA encompasses not only homopolymers of L-lactic acid or D-lactic acid, but also copolymers containing not less than 50 mass %, preferably not less than 75 mass %, more preferably not less than 85 mass %, and even more preferably not less than 90 mass %, of L-lactic acid or D-lactic acid repeating units, and it may be a stereocomplex polylactic acid obtained by mixing a poly-L-lactic acid and a poly-D-lactic acid. As the PGLA, a copolymer in which the ratio (mass ratio) of glycolic acid repeating units to lactic acid repeating units is from 99:1 to 1:99, preferably from 90:10 to 10:90, and more preferably from 80:20 to 20:80, may be used.

### (Melt Viscosity)

The aliphatic polyester, and preferably as the PGA, PLA, and/or PGLA typically has a melt viscosity from 50 to 5000 Pa·s, but preferably has a melt viscosity from 150 to 3000 Pas·s and more preferably from 300 to 1500 Pa·s. The melt viscosity is measured under a temperature of 240° C. and a shear rate of 122 sec⁻¹. If the melt viscosity is too low, the strength required in the mandrel provided in the plug for well drilling may be insufficient. If the melt viscosity is too high, a high melting temperature will be required in order to manufacture the mandrel, which may lead to thermal degradation of the aliphatic polyester, insufficiency of degradation, and the like. The melt viscosity described above is measured using a capirograph fitting with capillaries (diameter 1 mm φ×length 10 mm)(Capirograph 1-C, manufactured by Toyo Seiki Seisaku-Sho, Ltd.). A 20 g sample was held at a predetermined temperature (240° C.) for 5 minutes and subsequently measured at a shear rate of 122 sec⁻¹.

From the perspective of, for example, obtaining formability whereby cracking does not occur when molding by solidification-and-extrusion-molding, and the like, the PGA as the aliphatic polyester particularly preferably has a weight average molecular weight from 180,000 to 300,000, and a melt viscosity measured at a temperature of 270° C. and at a shear rate of 122 sec⁻¹ from 700 to 2000 Pa·s. Of these, the PGA is preferably a PGA having a weight average molecular weight from 190,000 to 240,000, and a melt viscosity measured at a temperature of 270° C. and at a shear rate of 122 sec⁻¹ of 800 to 1200 Pa·s. The melt viscosity is measured according to the method described above (the measurement temperature is set to 270° C.). The weight average molecular weight is measured using gel permeation chromatography (GPC) under the conditions described below. 10 μl of the solution to be measured is obtained by dissolving 10 mg of the PGA in hexafluoroisopropanol (HFlP) in which sodium trifluoroacetate is dissolved at a concentration of 5 mM to obtain a 10 mL solution and, thereafter, filtering the solution using a membrane filter.

### <GPC Measurement Conditions>

Device: LC-9A, manufactured by Shimadzu Corporation

Columns: Two HFlP-806M columns (connected in series)+one HFlP-LG precolumn manufactured by Showa Denko K.K.

Column Temperature: 40° C.

Eluent: HFlP solution in which sodium trifluoroacetate is dissolved at a concentration of 5 mM

Flow rate: 1 mL/min

Detector: Differential refractometer

Molecular weight calibration: Data of a molecular weight calibration curve produced by using five types of polymethylmethacrylates having standard molecular weights that are different from each other (manufactured by Polymer Laboratories Ltd.) are used.

### [Other Blended Components]

The degradable material, preferably the decomposable resin, more preferably the aliphatic polyester, and even more preferably the PGA, may also contain or be blended with various additives as other blended components, such as resin materials (other resins when the degradable material is a decomposable resin), stabilizers, degradation accelerators or degradation inhibitors, reinforcing materials, and the like within a range that does not hinder the object of the present invention. The degradable material preferably contains a reinforcing material, and in this case, the degradable material can be called a degradable composite material. When the degradable material is decomposable resin, it is a so-called reinforced resin. The mandrel formed from the reinforced resin preferably is formed from an aliphatic polyester containing a reinforcing material.

### [Reinforcing Material]

As reinforcing materials, materials such as resin materials conventionally used as reinforcing materials with the objective of improving mechanical strength or heat resistance may be used, and fibrous reinforcing materials or granular or powdered reinforcing materials may be used. The reinforcing materials may be contained typically in the amount of not greater than 150 parts by mass, and preferably in the range of 10 to 100 parts by mass, relative to 100 parts by mass of the degradable material such as decomposable resin.

Examples of fibrous reinforcing materials include inorganic fibrous substances such as glass fibers, carbon fibers, asbestos fibers, silica fibers, alumina fibers, zirconia fibers, boron nitride fibers, silicon nitride fibers, boron fibers, and potassium titanate fibers; metal fibrous substances such as stainless steel, aluminum, titanium, steel, and brass; and organic fibrous substances with a high melting point such as aramid fibers, kenaf fibers, polyamides, fluorine resins, polyester resins, and acrylic resins; and the like. Short fibers having a length of not greater than 10 mm, more preferably 1 to 6 mm, and even more preferably 1.5 to 4 mm are preferable as the fibrous reinforcing materials. Furthermore, inorganic fibrous substances are preferably used, and glass fibers are particularly preferable.

As the granular or powdered reinforcing material, mica, silica, talc, alumina, kaolin, calcium sulfate, calcium carbonate, titanium oxide, ferrite, clay, glass powder, zinc oxide, nickel carbonate, iron oxide, quartz powder, magnesium carbonate, barium sulfate, and the like can be used. These reinforcing materials may be each used alone or in combinations of two or more types. The reinforcing material may be treated with a sizing agent or surface treatment agent as necessary.

### [Composite Material]

The mandrel 1 formed from the degradable material may be formed from a composite material including the degradable material and a metal or inorganic substance. Specific examples include composite materials in which recessed portions such as indentations having a predetermined shape are provided in a base material formed from the degradable material such as a decomposable resin exemplified by PGA, or the like; a metal (metal fragment or the like) or an inorganic substance having a shape that matches the shape of the recessed portion is fitted therein; and the base material and the metal or inorganic substance are fixed using an adhesive or wrapped and fixed with wires or fibers so that the fixed state of the base material and the metal fragments or inorganic substance is maintained.

### [Ring-Shaped Ratchet Structure]

A ring-shaped ratchet structure orthogonal to the axial direction of the mandrel is provided on the outer circumferential surface of the mandrel 1 of the plug for well drilling of the present invention. The ring-shaped ratchet structure is formed from a plurality of interlocking parts that allow movement of the members attached on the outer circumferential surface orthogonal to the axial direction of the mandrel in one direction along the axial direction of the mandrel and restrict movement in the opposite direction. Note that in cases where multiple members attached on the outer circumferential surface orthogonal to the axial direction of the mandrel are present, each of the members may be provided with the ring-shaped ratchet structure, or a portion, that is, at least one of the members may be provided with the ring-shaped ratchet structure. Further description of the ring-shaped ratchet structure orthogonal to the axial direction of the mandrel will be given later.

### [Shearing Stress at a Temperature of 66° C.]

In cases where the mandrel 1 of the plug for well drilling of the present invention is formed from the degradable material, the mandrel 1 preferably is formed from a degradable material having a shearing stress of 30 MPa or greater at a temperature of 66° C. Specifically, when the mandrel 1 is formed from the degradable material having a shearing stress of 30 MPa or greater at a temperature of 66° C., the plurality of interlocking parts, which constitute the ring-shaped ratchet structure orthogonal to the axial direction of the mandrel, formed on the outer circumferential surface of the mandrel 1 have no risk of deforming or becoming damaged when subjected to high pressures in the axial direction of the mandrel caused by the fracturing fluid or the like. As a result, there is no need to reduce the number of interlocking parts (also called “mountains”) forming the ratchet structure or excessively enlarge the cross-sectional area of the mountains. The shearing stress at a temperature of 66° C. of the degradable material forming the mandrel 1 is preferably 40 MPa or greater, and more preferably 50 MPa or greater. The upper limit of the shearing stress at a temperature of 66° C. is not particularly limited, but is normally not greater than 600 MPa, and often not greater than 450 MPa.

### [Thickness Reduction After Water Immersion]

In cases where the mandrel 1 of the plug for well drilling of the present invention is formed from the degradable material, the mandrel 1 preferably has a thickness reduction of less than 5 mm after being immersed in water of a temperature of 66° C. for one hour, and a thickness reduction of 10 mm or greater after being immersed in water of a temperature of 149° C. for 24 hours. Specifically, when the mandrel 1 has a thickness reduction of less than 5 mm, more preferably less than 4 mm, and even more preferably less than 3 mm after being immersed in water of a temperature of 66° C. for one hour, there is little probability that the degradable material forming the mandrel 1 will degrade (as described above, “degrade” includes disintegration and decreases in strength as well) in downhole environments of around 66° C. As a result, there is no risk of the ring-shaped ratchet mechanism interlocking parts deforming (including shrinkage) and/or becoming damaged, and well treatment such as fracturing, where high pressures are applied by the fluid in the axial direction of the mandrel, and the like can be reliably carried out according to a desired time schedule such as, for example, from a few hours to a few days, to a week. The lower limit of the thickness reduction after immersion in water of a temperature of 66° C. for one hour is not particularly limited, and is preferably 0 mm, but may also be about 0.1 mm. At the same time, when the mandrel 1 has a thickness reduction of 10 mm or greater, more preferably 12 mm or greater, and even more preferably 15 mm or greater after being immersed in water of a temperature of 149° C. for 24 hours, the degradable material forming the mandrel 1 will degrade (as described above, “degrade” includes disintegration and decreases in strength as well), leading to the deformation (including shrinkage) and/or damage of the ring-shaped ratchet mechanism interlocking parts. As a result, the plugging (fluid sealing) of the borehole by the plug for well drilling can be released in a short period of time, for example, from a few hours to a few days by bringing a fluid having a temperature of, for example, 149° C. into contact with the mandrel 1 after the completion of fracturing and other well treatment. The upper limit of the thickness reduction after immersion in water of a temperature of 149° C. for 24 hours is not particularly limited, and is preferably 100% of the thickness (or diameter) of the mandrel 1, but may also be about 95%.

### [Tensile Load Capacity of the Interlocking Parts of the Ratchet Structure at a Temperature of 66° C.]

In the mandrel 1 of the plug for well drilling of the present invention, as described later, a tensile load capacity of the interlocking parts of the ratchet structure is preferably 5 kN or greater at a temperature of 66° C. If the tensile load capacity (tensile load capacity of one mountain) of the interlocking parts of the ratchet structure at a temperature of 66° C. is too small, multiple interlocking parts will need to be provided in the ratchet structure, and the length of the ratchet structure will be too long.

### 2. Members Attached on the Outer Circumferential Surface Orthogonal to the Axial Direction of the Mandrel

The plug for well drilling of the present invention is provided with a mandrel and members attached on the outer circumferential surface orthogonal to the axial direction of the mandrel. Specifically, various members are attached on the outer circumferential surface of the mandrel in order to efficiently and reliably transport the plug, plug the borehole, and carry out fracturing, and for the purpose of improving the ease of handling of the plug. Examples of the members include members attached on the outer circumferential surface orthogonal to the axial direction of the mandrel, members attached on the outer circumferential surface along the axial direction of the mandrel, members attached on the outer circumferential surface in another direction relative to the axial direction of the mandrel, and the like. The present invention relates to a plug for well drilling provided with members attached on the outer circumferential surface orthogonal to the axial direction of the mandrel (hereinafter also referred to as “outer circumferential surface-attached members”). The present invention is described below while referencing FIGS. 1A and 1B, and FIG. 2.

Provided that the outer circumferential surface-attached members are members used conventionally in plugs for well drilling, they are not particularly limited, and examples thereof include at least one selected from the group consisting of slips 2a and 2b, wedges 3a and 3b, a pair of ring-shaped fixing members 4a and 4b, and a diametrically expandable circular rubber member 5. Note that in FIGS. 1A and 1B, and FIG. 2, a specific example in which two pairs of the combination of the slip and the wedge is illustrated but, as described later, one pair of the combination of the slip and the wedge may be provided, or three pairs or more may be provided. Additionally, a plurality of the pair of ring-shaped fixing members may be provided, or one ring of the pair of ring-shaped fixing members may be excluded. Furthermore, a plurality of the diametrically expandable circular rubber member 5 may be provided, or any of the slips, wedges, ring-shaped fixing members, or diametrically expandable circular rubber members may be excluded.

### [Material Forming the Outer Circumferential Surface-Attached Members]

The material forming the outer circumferential surface-attached members provided in the plug for well drilling of the present invention is not particularly limited. Materials used conventionally in the forming of outer circumferential surface-attached members provided in plugs for well drilling can be used. Examples include, metal materials (aluminum, steel, stainless steel, and the like), fibers, wood, composite materials, and resins. Specific examples include composite materials including carbon fibers or similar reinforcing materials, and particularly composite materials including an epoxy resin, phenol resin, or similar polymeric substances. As the plug for well drilling of the present invention will be able to reduce the costs and steps of well drilling as a result of the plug being removed following the completion of fracturing and the securing of the flow path being facilitated, at least one of the outer circumferential surface-attached members is preferably formed from the degradable material.

### [Degradable Material]

In the plug for well drilling of the present invention, in cases where at least one of the outer circumferential surface-attached members is formed from a degradable material, as described above with regards to the mandrel 1, the degradable material is preferably a decomposable resin, more preferably an aliphatic polyester, and even more preferably PGA. The members formed from the degradable material, that is, the at least one of the outer circumferential surface-attached members, are preferably formed from a degradable material having a shearing stress of 30 MPa or greater at a temperature of 66° C., and the degradable material is the same as that previously described for the mandrel 1.

### [Slips and Wedges]

A combination of slips 2a and 2b and wedges 3a and 3b is known in plugs for well drilling as a means for securing the plug to the borehole. Specifically, the slips 2a and 2b formed from a metal, inorganic substance, resin, or similar material are placed so as to be in slidable contact with the upper surface of the wedges 3a and 3b formed from material such as a compound resin material. Due to the movement of the wedges 3a and 3b via force in the axial direction of the mandrel 1 being applied, the slips 2a and 2b ride up on the upper surface of the slated surface of the wedges 3a and 3b and move outward orthogonal to the axial direction of the mandrel 1. The outermost circumferential surface of the slips 2a and 2b, orthogonal to the axial direction of the mandrel 1, contacts an inside wall H of the borehole and, thus, the plug is secured to the inside wall H of the borehole. The slips 2aand 2b may be provided with one or more bent portions such as convex parts, stepped parts, grooves, rough surfaces (corrugation), or the like at the parts making contact with the inside wall H of the borehole in order to make the plugging (sealing) of the space between the plug and the borehole even more reliable. Additionally, the slips 2a and 2b may be pre-divided into a predetermined number of sections in the circumferential direction orthogonal to the axial direction of the mandrel 1, or, as illustrated in FIGS. 1A and 1B, may be provided with breaks that stop partway—not pre-divided into a predetermined number of sections—from one end to the other end along the axial direction. In cases where breaks are provided, the wedges 3a and 3b advance to the lower surface of the slips 2a and 2b due to force in the axial direction of the mandrel 1 being applied to the wedges 3a and 3b. As a result, the slips 2a and 2b split and separate along the breaks and an extended line thereof and each of the pieces subsequently move outward orthogonal to the axial direction of the mandrel 1. Note that this structure is known in the art. Note that in cases where the slips 2a and 2b or the wedges 3a and 3b are formed from the degradable material and also include a bent portion, a curvature radius of the bent portion is preferably from 0.5 to 50 mm. [Pair of Ring-Shaped Fixing Members]

At least one combination of the slips 2a and 2b and the wedges 3a and 3b are preferably placed between the pair of ring-shaped fixing members 4a and 4b so that the wedges 3a and 3b can be made to move when force in the axial direction of the mandrel 1 is applied thereto. Specifically, the pair of ring-shaped fixing members 4a and 4b are configured such that they can slide along the axial direction of the mandrel 1 on the outer circumferential surface of the mandrel 1 and such that the spacing therebetween can be changed. In addition, they are configured such that a force in the axial direction of the mandrel 1 can be applied to the pair of wedges 3a and 3b by coming into contact directly or indirectly with the end part along the axial direction of the one or the plurality of wedges 3a and 3b. Individual shapes and sizes of the pair of ring-shaped fixing members 4a and 4b are not limited provided that they can perform the functions described above. However, from the perspective of being able to effectively apply force in the axial direction of the mandrel 1 to the wedges 3a and 3b, the edge surfaces of the pair of ring-shaped fixing members 4a and 4b on each side contacting the wedges 3a and 3b are preferably flat. Each ring of the pair of ring-shaped fixing members 4a and 4b is preferably a circular ring which completely surrounds the outer circumferential surface of the mandrel 1, but may also have breaks or deformed places in the circumferential direction. In addition, as for the shape in which the circle is separated in the circumferential direction, the circle may be formed as desired. As each of the rings of the pair of ring-shaped fixing members 4a and 4b, a plurality of rings may be placed adjacently in the axial direction so as to form a wide ring-shaped fixing member (having a long length in the axial direction of the mandrel 1).

The pair of ring-shaped fixing members 4a and 4b may have the same or similar compositions, shapes and structures, or the compositions, shapes and structures may be different. For example, each of the ring-shaped fixing members may differ in outside diameter or length in the axial direction of the mandrel 1. In addition, for example, one of the rings of the pair of ring-shaped fixing members 4a and 4b may also be configured in a state disenabling sliding relative to the mandrel 1, as desired. In this case, due to the fact that the other ring-shaped fixing member of the pair of ring-shaped fixing members 4a and 4b slides on the outer circumferential surface of the mandrel 1, each ring of the pair of ring-shaped fixing members 4a and 4b contacts the edge along the axial direction of the wedges 3a and 3b. The description above should not be construed to limit the present invention and, as desired, the pair of ring-shaped fixing members 4a and 4b may be configured such that one of the rings of the pair of ring-shaped fixing members 4a and 4b is in a state disenabling sliding with respect to the mandrel 1. Examples of a such configurations include configurations wherein the mandrel 1 and one ring of the pair of ring-shaped fixing members 4a and 4b are integrally formed (in this case, the ring-shaped fixing member cannot slide freely with respect to the mandrel 1); and where a jaw clutch or similar clutch mechanism and/or mating mechanism is used (in this case, switching between states where the rings can and cannot slide with respect to the mandrel 1 is enabled). As the plug for well drilling in which the mandrel 1 and one of the rings of the pair of rings 4a and 4b are formed integrally, a plug for well drilling in which these components are formed by integral molding or a plug for well drilling formed by machining is provided. Note that in cases where the pair of ring-shaped fixing members 4a and 4b are formed from the degradable material and also include a bent portion, a curvature radius of the bent portion is preferably from 0.5 to 50 mm.

The plug for well drilling may be provided with a plurality of the pair of ring-shaped fixing members 4a and 4b. In this case, at least one of each of the combinations of the slips 2a and 2b and the wedges 3a and 3b and/or the diametrically expandable circular rubber member 5 may be placed, individually or in combination, at positions between the one or the plurality of the pair of rings 4a and 4b.

### [Diametrically Expandable Circular Rubber Member]

The plug for well drilling of the present invention may be provided with at least one diametrically expandable circular rubber member 5 placed at a position between the pair of ring-shaped fixing members 4a and 4b on the outer peripheral surface orthogonal to the axial direction of the mandrel 1. Preferably, the pair of ring-shaped fixing members 4a and 4b described above can be configured such that the diametrically expandable circular rubber member 5 attached on the outer circumferential surface orthogonal to the axial direction of the mandrel 1 is fixed in a compressed state. That is, due to the diametrically expandable circular rubber member 5 directly or indirectly contacting the pair of ring-shaped fixing members 4a and 4b, force in the axial direction of the mandrel 1 is transmitted on the outer circumferential surface of the mandrel. As a result, the diametrically expandable circular rubber member 5 diametrically shrinks by being compressed in the axial direction of the mandrel 1 and diametrically expands in the direction orthogonal to the axial direction of the mandrel 1. The circular rubber member 5 expands in diameter, and the outward part in the direction orthogonal to the axial direction comes into contact with the inside wall H of the borehole, and additionally, the inward part in the direction orthogonal to the axial direction comes into contact with the outer circumferential surface of the mandrel 1, thereby plugging (sealing) the space between the plug and the borehole. The diametrically expandable circular rubber member 5 is fixed in a compressed state by the pair of ring-shaped fixing members 4a and 4b. That is, a state of contact of the outer circumferential surface of the mandrel 1 with the inside wall H of the borehole can be maintained, with the diametrically expandable circular rubber member 5 being in a compressed state in the axial direction of the mandrel 1 and the diametrically expandable circular rubber member 5 being in an expanded state in the direction orthogonal to the axial direction of the mandrel 1, while fracturing is subsequently performed, which yields the function of maintaining the seal between the plug and the borehole.

The diameter expandable circular rubber member 5 is not limited with regard to its material, shape, or structure as long as it has the function described above. For example, by using a circular rubber member 5 having a shape in which the cross-section in the circumferential direction orthogonal to the axial direction of the mandrel 1 has an inverted U-shape, it can expand in diameter toward the vertex of the inverted U-shape as the tip portion of the U-shape is compressed in the axial direction of the mandrel 1. The diametrically expandable circular rubber member 5 comes into contact with the inside wall H of the borehole and the outer circumferential surface of the mandrel 1 when diametrically expanded so as to plug (seal) the space between the plug and the borehole, and a gap is present between the plug and the borehole when the diametrically expandable circular rubber member 5 is not expanded. Therefore, the length of the diametrically expandable circular rubber member 5 in the axial direction of the mandrel 1 is preferably from 10 to 70% and more preferably from 15 to 65% with respect to the length of the mandrel 1. As a result of this configuration, the plug for well drilling of the present invention has a sufficient sealing function, which yields a function of assisting to secure the plug to the borehole after sealing.

The plug for well drilling may comprise a plurality of diametrically expandable circular rubber members 5, and by so doing, it can plug (seal) the space between the plug and the borehole at a plurality of positions in the axial direction of the mandrel 1, and the function of assisting to secure the plug to the borehole can be achieved even more reliably. In cases where the plug for well drilling comprises a plurality of diametrically expandable circular rubber members 5, the composition, shape, structure, position in the axial direction of the mandrel 1, and the relative positional relationship with the pair of ring-shaped fixing members 4a and 4b of the plurality of diametrically expandable circular rubber members 5 may be selected as desired.

It is necessary that the sealing function of the diametrically expandable circular rubber member 5 is not lost even when it comes in contact with higher pressures and/or the fracturing fluid used in fracturing under deep subterranean high-temperature and high-pressure environments. Therefore, typically, the diametrically expandable circular rubber member 5 is preferably a rubber material having superior heat resistance, oil resistance, and water resistance. For example, nitrile rubber, hydrogenated nitrile rubber, acyrlic rubber and the like are often used. In cases where the diametrically expandable circular rubber member 5 is formed from the degradable material, examples of the degradable material that can be used include at least one degradable rubber selected from the group consisting of urethane rubber, natural rubber, isoprene rubber, ethylene propylene rubber, butyl rubber, styrene rubber, acrylic rubber, aliphatic polyester rubber, chloroprene rubber, polyester-based thermoplastic elastomer, and polyamide-based thermoplastic elastomer. Additionally, the diametrically expandable circular rubber member 5 may be a rubber structure formed from a plurality of rubber members such as a laminated rubber or may be a structure formed by laminating other members. Furthermore, the diametrically expandable circular rubber member 5 may be provided with one or more bent portions such as convex parts, stepped parts, grooves, rough surfaces (corrugation), or the like at the parts making contact with the inside wall H of the borehole in order to further ensure the plugging (sealing) of the space between the plug and the borehole and the assistance of the fixing the plug to the borehole at the time of diameter expansion.

### 3. Ring-Shaped Ratchet Structure Orthogonal to the Axial Direction of the Mandrel

The plug for well drilling of the present invention comprising the mandrel 1 and the outer circumferential surface-attached members is provided with a ring-shaped ratchet structure orthogonal to the axial direction of the mandrel 1 on an inner circumferential surface of at least one of the members and the outer circumferential surface of the mandrel 1. The ring-shaped ratchet structure is formed from a plurality of interlocking parts that allow movement of the members in one direction along the axial direction of the mandrel 1 and restrict movement in the opposite direction.

In other words, in the plug for well drilling of the present invention comprising the mandrel 1 and the outer circumferential surface-attached members, the mandrel and the outer circumferential surface-attached members cooperate to plug a borehole and enable fracturing. As mining regulations such as those pertaining to mining at deeper levels have become stricter and more diversified, the mandrel 1 and the outer circumferential surface-attached members provided in the plug for well drilling must be able to withstand the large load placed on the plug so that the plug can reliably be transported into the well, the borehole can be plugged, and fracturing can be carried out. Due to the fact that the plug for well drilling of the present invention has a unique structure in that it is provided with the ring-shaped ratchet structure, it can reliably be transported into the well, the borehole can be plugged, and fracturing can be carried out.

Specifically, when a borehole is plugged and fracturing is carried out, 8,000 weight pound or greater of high hydraulic pressure is applied, resulting in a typical load of 50 kN or greater, in some cases 100 kN or greater, and depending on the amount of high hydraulic pressure applied, 200 kN or greater or even 300 kN or greater being applied to the plug for well drilling. The plug for well drilling of the present invention is provided with the ring-shaped ratchet structure orthogonal to the axial direction of the mandrel 1 on an inner circumferential surface of at least one of the members and the outer circumferential surface of the mandrel. The ring-shaped ratchet structure is formed from a plurality of interlocking parts that allow movement of the member in one direction along the axial direction of the mandrel 1 and restrict movement in the opposite direction. Particularly, it is preferable that the necessary number of the interlocking parts be formed and/or the interlocking depth be further increased (increase the cross-sectional area of the interlocking parts) so that the ratchet structure will have a gross tensile load capacity capable of withstanding a load of 50 kN or greater. The gross tensile load capacity of the ratchet structure is more preferably made to be 100 kN or greater, and even more preferably 200 kN or greater, and the upper limit thereof is typically 500 kN.

### [Interlocking Parts]

More specifically, as illustrated in FIG. 2, ring-shaped tooth part r1 orthogonal to the axial direction of the mandrel 1 is formed on the outer circumferential surface of the mandrel 1 (in FIG. 2, four teeth are schematically depicted), and a toothed member T is attached to the inner circumferential surface of an outer circumferential surface-attached member (in FIG. 2, the ring-shaped fixing member 4a is depicted), which results in ring-shaped tooth part r2 orthogonal to the axial direction of the mandrel 1 being formed (in FIG. 2, four teeth are schematically depicted); and the ratchet mechanism interlocking part R is formed from the tooth part r1 and the tooth part r2 (in FIG. 2, four of the interlocking parts are schematically depicted). When a force in the right-left direction as shown by the arrow in FIG. 2 is applied, movement of the outer circumferential surface-attached member is restricted due to the presence of the interlocking parts, and the coupled state of the mandrel 1 and the outer circumferential surface-attached member is maintained.

On the other hand, when a force in the left-right direction as shown by the arrow in FIG. 2 is applied, the ring-shaped tooth part r2 formed on the inner circumferential surface of the outer circumferential surface-attached member is enabled to move over the ring-shaped tooth part r1 formed on the outer circumferential surface of the mandrel 1. Thus, the interlocking parts are configured so as to allow movement of the outer circumferential surface-attached member.

The tensile load capacity of each of the interlocking parts depends on the magnitude of the shearing stress of the material with the smaller shearing stress of the materials forming the tooth part r1 and the tooth part r2 that constitute the interlocking part, in the temperature of the environment where the interlocking parts are present. For example, in a case where one of the tooth parts is formed from PGA as the degradable material, and the other tooth part is formed from a metal, the shearing stress at 66° C. (equivalent to about 150° F.) of the PGA will be 56 MPa, which is normally smaller than the shearing stress of a metal. Accordingly, if, for example, the area of the interlocking parts of the tooth parts is 400 mm², the tensile load capacity of the interlocking parts is calculated from the shearing stress of the PGA and is approximately 22 kN.

The tensile load capacity at a temperature of 66° C. of the interlocking parts of the ring-shaped ratchet structure can be adjusted on the basis of the selection of the material forming the tooth parts and particularly on the basis of the selection of the type of degradable material, cross-sectional area of the interlocking parts of the tooth parts, and the like, but the tensile load capacity is preferably 5 kN or greater, more preferably 8 kN or greater, and even more preferably 10 kN or greater. The upper limit of the tensile load capacity at a temperature of 66° C. of the interlocking parts is typically 100 kN. When making these selections, considering that the plug for well drilling of the present invention is provided with the mandrel 1 and at least one of the outer circumferential surface-attached members formed from the degradable material, various parameters must be taken into account such as the strength of the mandrel 1, the effect of degradation in the environment the plug for well drilling is used, and the like in cases where, as discussed later, the tooth parts are formed on the outer circumferential surface of the mandrel 1 that is formed from the degradable material.

### [Ring-Shaped Ratchet Structure]

In order to provide the ring-shaped ratchet structure with a gross tensile load capacity capable of withstanding the load generated when plugging a borehole and carrying out fracturing, for example 50 kN at a temperature of 66° C., the ratchet structure should have the required number of the interlocking parts in accordance with the tensile load capacity of the interlocking parts at a temperature of 66° C. For example, in a case where the tensile load capacity of the interlocking parts at a temperature of 66° C. is 5 kN or greater, a ratchet structure having ten of the interlocking parts (also called “10 mountains”) should be provided. The number of the tooth parts (interlocking parts) in the ring-shaped ratchet structure can be set as appropriate, taking into account the tensile load capacity of the interlocking parts at a temperature of 66° C. and the gross tensile load capacity required of the ratchet structure in borehole environments, and is typically in a range of 2 to 20 and often in a range of 3 to 15. For example, a ratchet structure having a gross tensile load capacity of about 130 kN can be configured by providing five tooth parts (interlocking parts) formed from PGA (PGA has a shearing stress at a temperature of 66° C. of 56 MPa) that have a width of 4 mm and a depth of 2.4 mm.

With the ring-shaped ratchet structure orthogonal to the axial direction of the mandrel in the plug for well drilling of the present invention, due to the fact that the required number of interlocking parts described above are provided on the outer circumferential surface of the mandrel and the inner circumferential surface of the outer circumferential surface-attached members, movement in one direction along the axial direction of the mandrel is allowed and movement in the opposite direction is restricted.

The interlocking parts formed on the outer circumferential surface of the mandrel and the inner circumferential surface of at least one of the outer circumferential surface-attached members are formed by directly engraving the tooth parts via machining or the like into one or both of the outer circumferential surface of the mandrel and the inner circumferential surface of the outer circumferential surface-attached member. Additionally, due to the fact that the metal ring-shaped member or the like provided with the tooth part for forming the interlocking parts is used, the ring-shaped ratchet structure may be formed so as to cover one or both of the outer circumferential surface of the mandrel and the inner circumferential surface of at least one of the outer circumferential surface-attached members.

The ring-shaped ratchet structure may be formed from a metal, and specifically may be formed from aluminum or iron (carbon steel, stainless steel, or the like). In many cases, the ring-shaped ratchet structure can be obtained by engraving the required number of tooth parts for forming the interlocking parts by machining the aluminum, iron, or similar metal material and, as necessary, inserting the toothed member, having its shape adjusted into a ring shape, on the outer circumferential surface of the mandrel or, as illustrated in FIG. 2, on the inner circumferential surface of at least one of the outer circumferential surface-attached members, and fixing and covering via a standard method.

Additionally, the ring-shaped ratchet structure may be formed from the decomposable resin or similar degradable material. In many cases, the tooth parts forming the interlocking parts can be formed by machining the inner circumferential surface of at least one outer circumferential surface-attached members or the outer circumferential surface of the mandrel formed from the degradable material. Furthermore, it is preferable that the ring-shaped ratchet structure is formed from the degradable material because, after a given period of time passes following the completion of blocking treatment via fracturing, due to the decomposition of the degradable material, the volume of the tooth parts forming the interlocking parts of the ratchet structure will decrease and the interlock will release and, as a result of the decomposition of the ratchet structure, part or all of the plug for well drilling will decompose.

### [Pushing Jig]

A seal between the plug and the borehole and the fixing of the plug are necessary in order to carry out well treatment, such as fracturing or the like where high fluid pressure is applied, using the plug for well drilling of the present invention which is provided with the ring-shaped ratchet structure having the plurality of interlocking parts formed on the outer circumferential surface of the mandrel 1 and the inner circumferential surface of at least one of the outer circumferential surface-attached members. As described above, typically, the diametrically expandable circular rubber member 5 diametrically shrinks by being compressed in the axial direction of the mandrel 1 and diametrically expands in the direction orthogonal to the axial direction of the mandrel 1, and the outward part thereof contacts the inside wall H of the borehole and, additionally, the inward part in the direction orthogonal to the axial direction comes into contact with the outer circumferential surface of the mandrel 1, thereby plugging (sealing) the space between the plug and the borehole. Moreover, as a result of force in the axial direction of the mandrel 1 being applied, the slips 2a and 2b move outward orthogonal to the axial direction of the mandrel 1 along with the movement of the wedges 3a and 3b and the outermost circumferential surface of the slips 2a and 2b contacts the inside wall H of the borehole and, thus, the plug is secured to the inside wall H of the borehole. That is, with the plug for well drilling of the present invention, it is required that the diametrically expandable circular rubber member 5, and the slips 2a and 2b and the wedges 3a and 3b be movable in the axial direction of the mandrel 1 and be fixable at predetermined positions; and also required that the diametrically expandable circular rubber member 5 and the like have resilience, can withstand the high fluid pressure applied when carrying out well treatment such as fracturing, and that the predetermined positions of the members can be maintained. Accordingly, with the plug for well drilling of the present invention, the members attached on the outer circumferential surface orthogonal to the axial direction of the mandrel 1 preferably include one or a plurality of pushing jigs having interlocking parts that form a ring-shaped ratchet structure on an inner circumferential surface thereof.

As described previously, the movement in the axial direction of the diametrically expandable circular rubber member 5 and the slips 2a and 2b and the wedges 3a and 3b is typically carried out by directly or indirectly contact with the pair of ring-shaped fixing members 4a and 4b. The plug for well drilling may comprise at least one of the pushing jigs as one of the rings of the pair of ring-shaped fixing members 4a and 4b (hereinafter, also referred to as “ring-shape fixing member 4a”, for convenience). Additionally, in the plug for well drilling, as a member separate from the ring-shape fixing member 4a, at least one of the pushing jigs may be an outer circumferential surface-attached member arranged along the axial direction of the mandrel 1.

The shape, structure, and material of the pushing jig having interlocking parts that form a ring-shaped ratchet structure on the inner circumferential surface thereof are not particularly limited, provided that they perform the functions described above and, for example, the pushing jig may be formed from a metal, inorganic material, resin (or decomposable resin), composite material (e.g. reinforcing material-containing resin), or the like. From the perspectives of the resilience of the diametrically expandable circular rubber member 5 and the like, the strength to withstand the fluid pressure caused by fracturing fluid and the like, and degradability, at least one of the pushing jigs is preferably formed from a metal and/or degradable material, and may also be formed from a combination of a metal and/or degradable material and other materials. In cases where the plug for well drilling comprises a plurality of pushing jigs having interlocking parts that form a ring-shaped ratchet structure on the inner circumferential surface thereof as a member attached on the outer circumferential surface orthogonal to the axial direction of the mandrel 1, the plurality of pushing jigs may be attached in a connected manner or in an isolated manner along the axial direction of the mandrel 1; and the shape, structure, and material of the pushing jigs may be substantially the same or may differ.

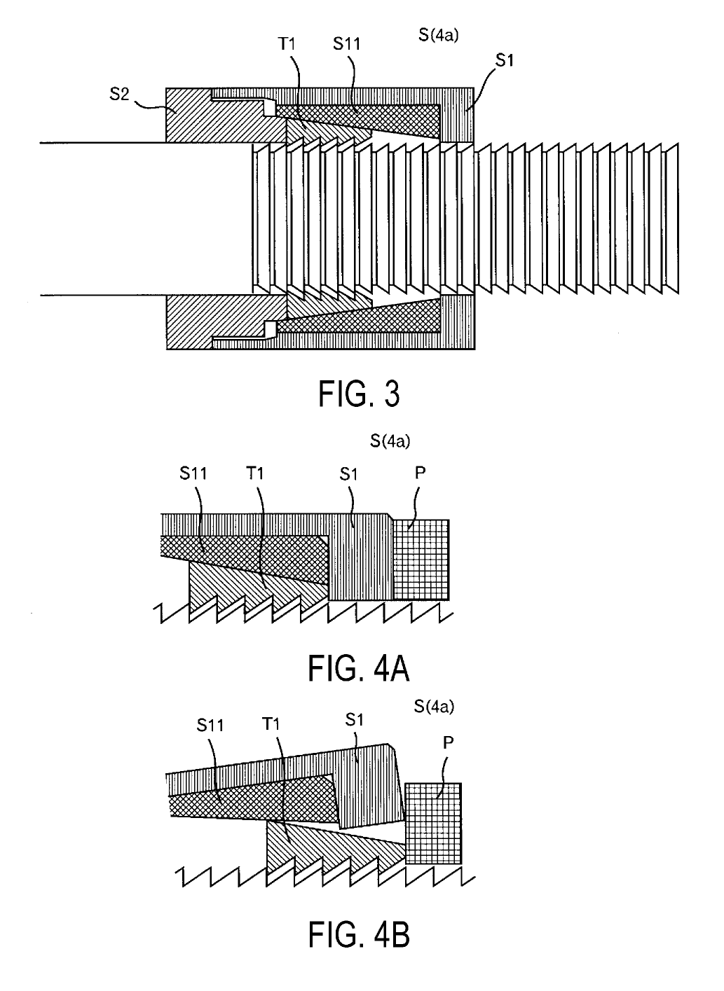

FIG. 3 illustrates a schematic partial cross-sectional view of a specific example of a pushing jig S (hereinafter also referred to as “pushing jig S (4a)”, as it is equivalent to the ring-shape fixing member 4a). The pushing jig S (4a) illustrated in FIG. 3 is provided with a ring-shaped pushing jig body S1 (formed integrally with S11 in the drawing) formed from, for example, the degradable material (PGA, or the like), and a ratchet structured ring T1 having interlocking parts that form a ring-shaped ratchet structure on the inner circumferential surface thereof (member equivalent to the toothed member T in FIG. 2; however, in FIG. 3, five interlocking parts are schematically depicted); and the inner circumferential surface of the pushing jig body S1 is in contact with the outer circumferential surface of the ratchet structured ring T1. In FIG. 3, the contact surface between the inner circumferential surface of the pushing jig body S1 and the outer circumferential surface of the ratchet structured ring T1 has a tapered shape diametrically shrinking toward the right side of FIG. 3. A pushing jig screw S2 formed from, for example, the degradable material (PGA, or the like) is screwed onto the trailing end (located on the left side of FIG. 3; fluid pressure from the fracturing fluid or the like is applied from the left side) along the axial direction of the mandrel 1 of the pushing jig body S1. Shape and size of the pushing jig S are not particularly limited and can be appropriately determined taking the material and well environment into consideration, but a range of the thickness is typically from 2 to 20 mm and is often from 3 to 15 mm, and a range of the width (length in the axial direction of the mandrel 1) is typically from 10 to 100 mm and is often from 15 to 50 mm.

Furthermore, the pushing jig body S1 of the pushing jig S specifically depicted in FIG. 3 as a preferred aspect is further provided with a support ring S11, as a separate part, formed from a metal (e.g. aluminum) and/or the degradable material on an inner side orthogonal to the axial direction of the mandrel 1, which is in contact with the outer circumferential surface of the ratchet structured ring T1. In this case, the inner circumferential surface of the pushing jig body S1 described previously contacts the outer circumferential surface of the support ring S11 and, as a result, the inner circumferential surface of the support ring S11 contacts the outer circumferential surface of the ratchet structured ring T1. A thickness of the support ring S11 is not particularly limited and can be appropriately determined taking the material, shape, thickness, and length of the pushing jig, the applied fluid pressure, the well environment, and the like into consideration, but a range of the smallest thickness to the greatest thickness is typically from 0.5 to 15 mm and is often from 1 to 10 mm. Note that the configuration of the pushing jig body S1 and the configuration and material of the pushing jig S should not be construed to be limited by this specific example.

Because the pushing jig S illustrated in FIG. 3 is provided with the configuration described above, when fluid pressure from the fracturing fluid or the like is applied from the trailing side (the left side in FIG. 3) along the axial direction of the mandrel 1, continual, strong force will press the diametrically expandable circular rubber member 5, and the slips 2a and 2b and the wedges 3a and 3b toward the leading side (the right side in FIG. 3) along the axial direction of the mandrel 1 and, as a result, the seal between the plug and the borehole can be maintained. Additionally, due to the fact that the pushing jig body S1 of the pushing jig S is provided with the support ring S11 formed from a metal and/or the degradable material, the pushing jig S can be provided with high strength and, particularly, risk of the ratchet structured ring T1 moving in the diametric expansion direction due to high fluid pressure and leading to the loss of the interlocking of the interlocking parts in the ratchet structure, can be mitigated. For example, by providing the support ring S11 formed from aluminum, the diametric expansion can be suppressed, even when hydraulic pressure of about 100 kN is applied. That is, at least one of the pushing jigs S preferably comprises the support ring S11 formed from a metal and/or the degradable material, wherein an inner circumferential surface of the support ring S11 contacts the outer circumferential surface of the ratchet structured ring T1 having interlocking parts that form a ring-shaped ratchet structure on the inner circumferential surface thereof.

### [Ring-Shaped Plate]

As shown in the schematic partially enlarged cross-sectional views FIGS. 4A and 4B which illustrate the vicinity of the ratchet structure, the plug for well drilling of the present invention preferably is further provided with a ring-shaped plate P adjacent to the leading side along the axial direction of the mandrel 1 of at least one of the pushing jigs S (in FIGS. 4A and 4B, a specific example of a plug for well drilling provided with one of the pushing jigs S is depicted). That is, with the plug for well drilling of the present invention, there is a risk that, due to the mandrel 1 and the pushing jig S, which are connected via the ratchet mechanism interlocking part, being pressed upon with great force by the fluid pressure from the fracturing fluid or the like toward the leading side (the right side in FIGS. 3, 4A and 4B) along the axial direction of the mandrel 1, the pushing jig S, specifically the ratchet mechanism interlocking part T1 may, as illustrated in FIG. 4B, slip under the inner side of the pushing jig body S1 due to being pressed strongly toward the right side of FIG. 4A via the ratchet structure, and protrude on the leading side along the axial direction of the mandrel 1 while pressing and expanding the pushing jig body S1. In such a case, the interlocking of the interlocking parts in the ratchet structure will be lost and, in extreme cases, the mandrel 1 may detach from the ratchet structure and jut out from the leading end of the plug for well drilling. As illustrated in FIG. 4B, the plug for well drilling of the present invention is provided with the ring-shaped plate P adjacent to the leading side along the axial direction of the mandrel 1 of the pushing jig S. Due to this configuration, even if the ratchet structured ring T1 slips under the inner side of the pushing jig body S1, the tip of the ratchet structured ring T1 will contact the ring-shaped plate P and, as a result, movement of the pushing jig S, specifically the ratchet structured ring T1, can be suppressed from moving toward the leading side along the axial direction of the mandrel 1. Accordingly, the interlocking of the interlocking parts in the ratchet structure will not be lost and the mandrel 1 will not detach from the ratchet structure.

The inner diameter of the ring-shaped plate P is substantially the same as the outer diameter of the mandrel 1 and the outer diameter of the ring-shaped plate P is less than the outer diameter of the pushing jig S. If the outer diameter of the ring-shaped plate P is greater than the outer diameter of the pushing jig S, the ring-shaped plate P may be subjected to fluid pressure from fracturing fluid or the like, or may contact the inside wall H or the like of a borehole when setting the downhole tool provided with the mandrel 1 in a borehole, which may lead to damage, deformation, or the like. In cases where the inner diameter of the ring-shaped plate P is less than the outer diameter of the pushing jig S, the ring-shaped plate can be integrally provided so as to be embedded at a position contacting the leading side of the pushing jig S along the axial direction of the mandrel 1. In cases where the plug for well drilling is provided with a plurality of the pushing jigs S as members attached on the outer circumferential surface orthogonal to the axial direction of the mandrel 1, each of the plurality of pushing jigs S is preferably provided with a ring-shaped plate P adjacent to the leading side along the axial direction. Furthermore, in cases where the plurality of pushing jigs S is attached in a connected manner along the axial direction of the mandrel 1, the ring-shaped plates P can be integrally provided so as to be embedded at positions contacting the trailing sides along the axial direction of the mandrel 1 of the pushing jigs S positioned on the leading side along the axial direction of the mandrel 1. In cases where the ring-shaped plate P is integrally provided so as to be embedded at a position contacting the leading side and/or the trailing side along the axial direction of the mandrel 1 of the pushing jig S, by providing a ring-shaped plate P that has been split into multiple sections in the circumferential direction, the ring-shaped plate P can be broken into small pieces after use and will not hinder the production of petroleum, natural gas, and the like.

A length along the axial direction of the mandrel 1 of the ring-shaped plate P is not particularly limited as long as pressure of the other outer circumferential surface-attached members interposed by the pushing jig S is not obstructed, and is typically in a range from 5 to 50% and often from 10 to 30% of the length in the axial direction of the mandrel of the pushing jig S. The ring-shaped plate P may be formed from a material such as a metal (aluminum, carbon steel, or the like), an inorganic material, a resin (or a decomposable resin as the degradable material), a composite material (reinforcing material-containing resin, or the like), or the like, and is preferably formed from the degradable material and/or a metal. As operations to remove the ring-shaped plate P after the completion of well treatment such as fracturing and the like will be unnecessary or simple, the ring-shaped plate P more preferably has the degradable material as a main component. Additionally, from the perspective of the strength of the contact of the pushing jig S, specifically the ratchet structured ring T1, preferably the contacting location is formed from a metal and the other locations are formed from the degradable material. Note that in cases where the ring-shaped plate P has been split into multiple sections in the circumferential direction and provided, there is an advantage in that degradation is accelerated when the ring-shaped plate P is formed from the degradable material and, moreover, even if the ring-shaped plate P is not formed from the degradable material, by forming, for example, the pushing jig S from the degradable material there is an advantage in that the ring-shaped plate P will be easily split into small pieces along with the degradation of the pushing jig S.

In the plug for well drilling of the present invention, due to the selection of the structure and material of the pushing jig S (preferably provided with the support ring S11) and the ring-shaped plate P previously described, the tensile load capacity of the interlocking parts in the ratchet structure at a temperature of 66° C. and the gross tensile load capacity of the ratchet structure in downhole environments can be made greater than in cases where the pushing jig S and the ring-shaped plate P are not provided. Additionally, by appropriately designing the value of the tensile load capacity of the interlocking parts in the ring-shaped ratchet structure at a temperature of 66° C. and the number of the interlocking parts, a plug for well drilling having a gross tensile load capacity as a plug of 100 kN or greater in downhole environments can be obtained and, furthermore, preferably a plug for well drilling having a gross tensile load capacity as a plug of 200 kN or greater and more preferably of 300 kN or greater can be obtained. The upper limit of the gross tensile load capacity of the plug for well drilling is not particularly limited but, from the perspective that it is not necessary to exceed the upper limit of the hydraulic pressure applied when carrying out fracturing or other well treatment, is typically 1000 kN or less and often 800 kN or less.

### 4. Plug for Well Drilling

The plug for well drilling of the present invention comprises a mandrel and outer circumferential surface-attached members, wherein:

a) at least one of the members or the mandrel is formed from a degradable material, and

b) a ring-shaped ratchet structure orthogonal to the axial direction of the mandrel is provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction. The plug for well drilling of the present invention can further comprise other members normally provided in plugs for well drilling. For example, in cases where the mandrel is provided with a hollow part along the axial direction, a ball (may be formed from a metal, resin, or similar material, or from a degradable material) can be provided in the hollow part for the purpose of controlling the flow of a fluid. Additionally, the mandrel and outer circumferential surface-attached members of the plug for well drilling, and also the other members described above may be provided with a member such as, for example, an anti-rotation member or the like for coupling and releasing the members with/from each other or other members. The entire plug for well drilling provided with the mandrel and the outer circumferential surface-attached members of the present invention may be formed from the degradable material.

### [Plugging of the Borehole]

As described above, with the plug for well drilling of the present invention, for example, due to the forces in the axial direction of the mandrel being applied to the pair of ring-shaped fixing members, the forces in the axial direction of the mandrel are transmitted to the diametrically expandable circular rubber member and, as a result, the diametrically expandable circular rubber member is compressed in the axial direction of the mandrel and, along with the reduction of distance of the axial direction (diametric compression), the diametrically expandable circular rubber member expands in a direction orthogonal to the axial direction of the mandrel. The circular rubber member diametrically expands and the outward part in the direction orthogonal to the axial direction comes into contact with the inside wall H of the borehole, and additionally, the inward part in the direction orthogonal to the axial direction comes into contact with the outer circumferential surface of the mandrel, and the slips ride up on the upper surface of the slated surface of the wedges and move outward orthogonal to the axial direction of the mandrel. The outermost circumferential surface of the slips orthogonal to the axial direction of the mandrel contacts an inside wall of the borehole, thereby plugging (sealing) the space between the plug and the borehole (borehole plugging). Then, in the state where the space between the plug and the borehole has been plugged (sealed), fracturing can be performed. After the well treatment such as fracturing has been completed, the diametrically expandable circular rubber member remains inside the borehole in the diametrically-expanded state, and by working together with the combination of the slip and wedge, can fix the plug for well drilling at a predetermined position of the borehole. Due to the fact that the plug for well drilling of the present invention is provided with the ring-shaped ratchet structure orthogonal to the axial direction of the mandrel, even in cases where high pressures, for example, pressures exceeding 50 kN are applied to the plug for well drilling during fracturing, relative movement along the axial direction of the mandrel and the outer circumferential surface-attached members is restricted and the plugging of the borehole is maintained. Furthermore, when the aforementioned plugging (sealing) or the like is performed in a downhole which is a high-temperature environment where the members of the plug for well drilling end up degrading in a short time, a treatment method can be employed in which the seal performance (strength and the like) can be maintained for a desired time by controlling the ambient temperature of the plug for well drilling by injecting fluid from above ground (cooldown injection).

### [Degradation of the Plug for Well Drilling]

When the production of oil, natural gas or the like begins after the completion of fracturing in the various prescribed sections, typically, the drilling of the well would be completed, and the well finished. At this time, with the plug for well drilling of the present invention, at least one of the members formed from the degradable material and attached on the outer circumferential surface orthogonal to the axial direction of the mandrel and, if desired, additionally the mandrel formed from the degradable material, can be easily degraded and removed. With the plug for well drilling of the present invention, by degrading or reducing the strength of the mandrel or the outer circumferential surface-attached members formed from the degradable material, in a short period of time following the completion of fracturing, the interlocking of the ring-shaped ratchet mechanism interlocking parts is released, degradation of the ring-shaped ratchet structure occurs, and the sealing of the borehole by the plug is removed at an early stage. Therefore, the degradation and removal of the plug for well drilling can be facilitated and hydrocarbon resources can be efficiently mined. As a result, with the plug for well drilling of the present invention, the substantial cost and time conventionally required to remove, recover, or destroy or fragmentize, by pulverization, perforation, or another method, many plugs for well drilling remaining inside a well after the completion of the well become unnecessary, which makes it possible to reduce the costs and/or steps of well drilling and completion. Furthermore, it is preferred that the members of the plug for well drilling remaining after the well treatment disappear completely by the time production begins, but even if they do not disappear completely, as long as they are in a state that their strength decreases and they can be disintegrated by stimulation such as water flow in the downhole, the disintegrated members of the plug for well drilling can be easily recovered by flowback or the like, and since it does not cause clogging in the downhole or fractures, it does not hinder production of the petroleum, natural gas, or the like. Additionally, normally, the higher the downhole temperature, the shorter the time required for degradation and strength decrease of the members of the plug for well drilling. Furthermore, depending on the well, the moisture content in the subterranean formation is sometimes low, and in this case, degradation of the downhole tool can be accelerated by allowing the water-based fluid used during fracturing to remain in the well without recovering it after fracturing.

### II. Method for Manufacturing Plug for Well Drilling

Provided that a plug for well drilling of the present invention is a plug for well drilling comprising a mandrel and outer circumferential surface-attached members, wherein: a) at least one of the members or the mandrel is formed from a degradable material, and b) a ring-shaped ratchet structure orthogonal to the axial direction of the mandrel is provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction;

the manufacturing method thereof is not particularly limited. For example, the plug for well drilling may be obtained by: molding each of the members provided in the plug for well drilling via a known method such as injection molding, extrusion molding (including solidification-and-extrusion molding), centrifugal molding, compression molding, or the like; machining each of the obtained members by cutting, perforating, or the like as necessary; and then assembling the members by known methods; and then either directly forming the ring-shaped ratchet structure orthogonal to the axial direction of the mandrel or covering the outer circumferential surface of the mandrel and/or the inner circumferential surface of the outer circumferential surface-attached members with the ring-shaped ratchet structure.

With the plug for well drilling of the present invention, in cases where the mandrel formed from the degradable material and the outer circumferential surface-attached members formed from the degradable material are integrally formed, the mandrel formed from the degradable material and the members formed from the degradable material and attached on the outer circumferential surface orthogonal to the axial direction of the mandrel are preferably integrally formed via integral molding by injection molding, extrusion molding (including solidification-and-extrusion molding), centrifugal molding, or the like, or by cutting or similar machining.

### III. Well Drilling Method

According to a well drilling method using the plug for well drilling comprising the mandrel and the outer circumferential surface-attached members of the present invention, in which a part or all of the plug for well drilling is degraded after the blocking of the borehole, when the fracturing in the various prescribed sections is completed, or the digging of the well is finished and the well completed, and the production of oil, natural gas, or the like begins, at least one of the members attached on the outer circumferential surface orthogonal to the axial direction of the mandrel and/or, if desired, additionally the mandrel formed from the degradable material, can be easily degraded and removed, via biodegrading, hydrolyzing, or degrading chemically by some other method. Additionally, according to the well drilling method of the present invention in which the ring-shaped ratchet structure is degraded as a result of the degradation or strength decrease of the mandrel or the outer circumferential surface-attached members formed from the degradable material, the degradation and removal of the plug for well drilling can be carried out even easier and hydrocarbon resources can be efficiently mined. As a result, with the well drilling method of the present invention, the substantial cost and time conventionally required to remove, recover, or destroy or fragmentize, by pulverization, perforation, or another method, many plug for well drilling remaining inside wells after the completion of the wells become unnecessary, which makes it possible to reduce the cost or steps of well drilling.

### INDUSTRIAL APPLICABILITY

The present invention provides a plug for well drilling comprising a mandrel and members attached on an outer circumferential surface orthogonal to an axial direction of the mandrel, wherein:

a) at least one of the members or the mandrel is formed from a degradable material, and

b) a ring-shaped ratchet structure orthogonal to the axial direction of the mandrel is provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction.

In light of mining regulations such as those pertaining to mining at deeper levels becoming stricter and more diversified, and as a result of the configuration described above, a plug for well drilling is provided by which advantageous effects are provided in that well drilling costs and steps can be reduced by withstanding the large load placed on the plug so as to reliably be transported into the well, plug the borehole, and carry out fracturing; and facilitating the removal of the plug and the securing of the flow path. Therefore there is high industrial applicability.

Additionally, the present invention provides a well drilling method using the plug for well drilling, the method comprising degrading a part or all of the plug for well drilling after blocking a borehole.

As mining regulations such as those pertaining to mining at deeper levels have become stricter and more diversified, and as a result of the configuration described above, a well drilling method is provided by which advantageous effects are provided in that well drilling costs and steps can be reduced by withstanding the large load placed on the plug so as to reliably be transported into the well, plug the borehole, and carry out fracturing; and facilitating the removal of the plug and the securing of the flow path. Therefore there is high industrial applicability.

### REFERENCE SIGNS LIST

1: Mandrel
2a and 2b: Slips
3a and 3b: Wedges
4a and 4b: Ring-shaped fixing members
5: Diametrically expandable circular rubber member
H: Inside wall of the borehole
R: Ratchet mechanism interlocking part
T: Toothed member
r1 and r2: Teeth
S(4a): Pushing jig (ring-shaped fixing member)
S1: Pushing jig body
S11: Support ring
S2: Pushing jig screw
T1: Ratchet structured ring
P: Ring-shaped plate

1. A plug for well drilling comprising:
a mandrel; and
members attached on an outer circumferential surface orthogonal to an axial direction of the mandrel;
a) at least one of the members or the mandrel being formed from a degradable material, and
b) a ring-shaped ratchet structure orthogonal to the axial direction of the mandrel being provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction.

2. A plug for well drilling comprising:
a mandrel; and
members attached on an outer circumferential surface orthogonal to an axial direction of the mandrel;
a1) the mandrel being formed from a degradable material;
a2) at least one of the members being formed from a degradable material; and
b) a ring-shaped ratchet structure orthogonal to the axial direction of the mandrel being provided on an inner circumferential surface of at least one of the members and the outer circumferential surface of the mandrel, the ring-shaped ratchet structure being formed from a plurality of interlocking parts that allow movement of the member in one direction along the axial direction of the mandrel and restrict movement in the opposite direction.

3. The plug for well drilling according to claim 1, wherein the member attached on the outer circumferential surface orthogonal to the axial direction of the mandrel, having the plurality of interlocking parts formed on the inner circumferential surfaces thereof, is at least one selected from the group consisting of a slip, a wedge, a pair of ring-shaped fixing members, and a diametrically expandable circular rubber member.

4. The plug for well drilling according to claim 1, wherein the member attached on the outer circumferential surface orthogonal to the axial direction of the mandrel, having the plurality of interlocking parts formed on the inner circumferential surfaces thereof, is one or a plurality of pushing jigs.

5. The plug for well drilling according to claim 4, wherein at least one of the pushing jigs is one of the pair of ring-shaped fixing members.

6. The plug for well drilling according to claim 4, wherein at least one of the pushing jigs comprises a support ring formed from at least one of a metal and a degradable material, and an inner circumferential surface of the support ring contacts an outer circumferential surface of a ratchet structured ring having interlocking parts that form a ring-shaped ratchet structure on an inner circumferential surface thereof.

7. The plug for well drilling according to claim 4, further comprising a ring-shaped plate adjacent to a leading side along the axial direction of the mandrel of at least one of the pushing jigs.

8. The plug for well drilling according to claim 7, wherein the ring-shaped plate is formed from at least one of a degradable material and a metal.

9. The plug for well drilling according to claim 1, wherein
at least one of the following i) to iii) applies to the mandrel formed from the degradable material:
i) is formed from a degradable material having a shearing stress of 30 MPa or greater at a temperature of 66° C.;
ii) has a thickness reduction of less than 5 mm after being immersed in water of a temperature of 66° C. for one hour, and has a thickness reduction of 10 mm or greater after being immersed in water of a temperature of 149° C. for 24 hours; and
iii) a tensile load capacity of the interlocking parts of the ratchet structure is 5 kN or greater at a temperature of 66° C.

10. The plug for well drilling according to claim 1, wherein at least one of the members attached on the outer circumferential surface orthogonal to the axial direction of the mandrel is formed from a degradable material having a shearing stress of 30 MPa or greater at a temperature of 66° C.

11. The plug for well drilling according to claim 1, wherein a gross tensile load capacity is 100 kN or greater.

12. The plug for well drilling according to claim 1, wherein a gross tensile load capacity of the ring-shaped ratchet structure is 50 kN or greater.

13. The plug for well drilling according to claim 1, wherein the ring-shaped ratchet structure is formed so as to cover one or both of the outer circumferential surface of the mandrel and the inner circumferential surface of the members attached on the outer circumferential surface orthogonal to the axial direction of the mandrel.

14. The plug for well drilling according to claim 3, wherein the pair of ring-shaped fixing members is capable of fixing the diametrically expandable circular rubber member attached on the outer circumferential surface orthogonal to the axial direction of the mandrel in a compressed state.

15. The plug for well drilling according to claim 3, wherein at least one of a combination of the slip and the wedge is disposed between the pair of ring-shaped fixing members.

16. The plug for well drilling according to claim 15, comprising a plurality of the combination of the slip and the wedge.

17. The plug for well drilling according to claim 1, wherein the mandrel comprises a hollow part along the axial direction.

18. The plug for well drilling according to claim 1, wherein the degradable material is an aliphatic polyester.

19. The plug for well drilling according to claim 18, wherein the aliphatic polyester is polyglycolic acid.

20. The plug for well drilling according to claim 19, wherein the polyglycolic acid has a weight average molecular weight from 180000 to 300000, and a melt viscosity recorded at a temperature of 270° C. and a shear rate of 122 sec⁻¹ from 700 to 2000 Pa·s.

21. The plug for well drilling described according to claim 1, wherein the degradable material comprises a reinforcing material.

22. A well drilling method using the plug for well drilling according to claim 1, the method comprising degrading a part or all of the plug for well drilling after blocking a borehole.

23. The well drilling method according to claim 22, comprising degrading the ring-shaped ratchet structure.
